(19) United States
(12) Patent Application Publication
(10) Pub. No.: US 2006/0214552 A1
(43) Pub. Date: Sep. 28, 2006

(54) Material for aperture grill color image receiving tube, aperture grill, and color image receiving same

(75) Inventors: Toshiyuki Ueda, Yamaguchi (JP); Hideo Ikeda, Yamaguchi (JP); Shinichi Aoki, Yamaguchi (JP)

Correspondence Address: BROWDY AND NEIMARK, P.L.L.C.;624 NINTH STREET, NW, SUITE 300, WASHINGTON, DC, 20001-5303, US

(73) Assignee: TOYO KOHAN CO. LTD, Chiyoda-ku (JP)

(21) Appl. No.: 10/531,718

(22) PCT Filed: Oct. 10, 2003
(86) PCT No.: PCT/JP03/13002

§ 371 Date: Apr. 24, 2006

(30) Foreign Application Priority Data
Oct. 18, 2002 (JP) 2002-303868

(51) Int. Cl. H01J 29/80

(52) U.S. Cl. 313/402

(57) ABSTRACT

A material for an aperture grill for a color image receiving tube which comprises a low carbon alloy steel containing 0.60 wt % or more or Mn, 0.051 wt % or more of Si, 0.03 wt % or less of AI and the balanced amount of Fe and inevitable impurities; an aperture grill using the material; and an image receiving tube equipped with the aperture grill. The aperture grill exhibits uniform and excellent magnetic characteristics within a coil and the color image receiving tube is free form the occurrence or color discrepancy.

### TECHNICAL FIELD

This invention relates to a material for an aperture grill for a color image receiving tube, an aperture grill and a color image receiving tube in which it is incorporated. More particularly, it relates to a material having excellent tensile strength and high-temperature creep strength for an aperture grill for a color image receiving tube, an aperture grill and a color image receiving tube in which it is incorporated.

### BACKGROUND ART

A material for an aperture grill used in a color image receiving tube, or a color picture tube is required to have a tensile strength of at least 750 MPa, since an aperture grill is subjected to a high tensile force when it is welded to a frame during its manufacture. Accordingly, a low-carbonsteel sheet strengthened by intensive working is now used as a material for an aperture grill for a color picture tube.

An aperture grill welded to a frame is heat treated for blackening and its heat treatment is carried out at a temperature of 455° C. below the recrystallization temperature of steel for a short time in the order of, say, 15 minutes, so that the tapes forming the blackened aperture grill may keep its state loaded with a tensile force without becoming loose. However, no diffusion phenomenon can be avoided under those conditions for blackening heat treatment, but diffusion causes the tapes to expand and eventually become twisted or broken. Accordingly, a material for an aperture grill for a color picture tube is required to have a tensile strength of 750 MPa or above and a creep strength not allowing it to expand when subjected to 15 minutes of blackening heat treatment at 455° C., or in other words, having an elongation of 0.4% or below when loaded with a tensile stress of 294 MPa.

A color picture tube is composed of an electron gun and a fluorescent screen for converting an electron beam to a picture, and has an inside covered with a magnetic shielding material to prevent any deflection of the electron beam by earth magnetism. An aperture grill is required to function as a magnetic shielding material, too, and is required to have as magnetic properties a high magnetic flux density (Br) and a low coercive force (Hc), i.e. a high ratio of magnetic flux density to coercive force (Br/Hc). However, a low-carbon steel sheet strengthened for a high yield strength as stated above, and subjected to blackening heat treatment at a temperature below its recrystallization temperature has a magnetic flux density as low as 0.8 tesla (T) or less, and a coercive force as high as about 400 A/m, i.e. a Br (T)/Hc (A/m) ratio as low as about 0.002, and is, therefore, inferior as a magnetic shielding material.

A strengthening method relying on solid solutions of C, N, etc. is known as a method of improving the tensile yield strength of a low-carbon steel sheet, but an increase of C and N in steel means an increase of carbide and nitride which prevent the movement of magnetic walls and thereby lower the magnetic properties of steel. A method relying on the precipitation of carbide, etc. in steel is known as a method of improving its creep strength, but is not adopted as a method of manufacturing a material for an aperture grill for a color picture tube now, since the majority of the precipitates have a large particle diameter in the order of microns which hinders the movement of magnetic walls and thereby lowers the magnetic properties of the material seriously.

Referring to another steel sheet material for an aperture grill type mask, Japanese Patent No. 2,548,133, for example, publishes a method in which the high strength and high-temperature creep characteristics of a very low-carbon steel sheet containing 40 to 100 ppm of N and 0.20 to 0.60% by weight of Mn are utilized for reducing its creep elongation during its blackening treatment. As the solute atoms N has an extremely smaller radius than the solvent atoms Fe, N forms an interstitial solid solution in the crystal lattice of Fe and produces the so-called Cottrell atmosphere. A reduction in creep elongation is considered to occur, since the N atoms have a high diffusion rate in Fe at a high temperature like the blackening temperature, gather around the sites of creep elongation, or dislocation creep and form a Cottrell atmosphere like clouds and thereby act to suppress the motion of dislocation creep.

These methods are, however, limited in applicability, since the aperture grill is required to function as a magnetic shielding material, too, and have high soft magnetic properties.

It is an object of this invention to provide a material for an aperture grill for a color picture tube having higher magnetic properties than any existing material, as well as excellent tensile strength and high-temperature creep strength, and a method of manufacturing the same.

### DISCLOSURE OF THE INVENTION

As a result of various research efforts to attain the technical object as stated above, we, the inventors of this invention, have arrived at this invention by discovering a strengthening phenomenon of Si in a solid solution when employing 0.051% byweight or more of Si, and thereby realizing high strength characteristics with excellent handling resistance.

Thus, the most important technical object of this invention as herein disclosed has been attained by employing 0.051% by weight or more of Si and realizing high strength characteristics with excellent handling resistance by a strengthening effect of a solid solution of silicon.

According to this invention, there is provided a material for an aperture grill for a color picture tube, characterized by being composed of a low-carbon alloy steel containing 0.60% by weight or more of Mn, 0.051% by weight or more of Si and 0.03% by weight or less of Al, the balance of its composition being Fe and unavoidable impurities.

According to this invention, there is also provided a material for an aperture grill for a color picture tube, characterized by being composed of a low-carbon alloy steel containing 0.05% by weight or less of C, 0.60% by weight or more of Mn, 0.051% by weight or more of Si and 0.03% by weight or less of Al, the balance of its composition being Fe and unavoidable impurities.

According to this invention, there is also provided a material for an aperture grill for a color picture tube, characterized by being composed of a low-carbon alloy steel strip containing 0.60% by weight or more of Mn, 0.051% by weight or more of Si and 0.03% by weight or less of Al, the balance of its composition being Fe and unavoidable impurities, and heat treated for shape correction at a temperature not causing its recrystallization.

According to this invention, there is also provided a material for an aperture grill for a color picture tube, characterized by being composed of a low-carbon alloy steel strip containing 0.03% by weight or less of C, 0.60% by weight or more of Mn, 0.051% by weight or more of Si and 0.03% by weight or less of Al, the balance of its composition being Fe and unavoidable impurities, and heat treated for shape correction at a temperature not causing its recrystallization.

According to this invention, there is also provided a material for an aperture grill for a color picture tube, characterized by being composed of a low-carbon alloy steel strip containing 0.60% by weight or more ofMn, 0.051% by weight or more of Si and 0.03% by weight or less of Al, the balance of its composition being Fe and unavoidable impurities, subjected to surface roughening treatment giving a surface roughness Ra (JIS B 0601) of 0.1 to 0.8 μm, and heat treated for shape correction at a temperature not causing its recrystallization.

According to this invention, there is also provided a material for an aperture grill for a color picture tube, characterized by being composed of a low-carbon alloy steel strip containing 0.03% by weight or less of C, 0.60% by weight or more of Mn, 0.051% by weight or more of Si and 0.03% by weight or less of Al, the balance of its composition being Fe and unavoidable impurities, subjected to surface roughening treatment giving a surface roughness Ra (JIS B 0601) of 0.1 to 0.8 μm, and heat treated for shape correction at a temperature not causing its recrystallization.

Every material as set forth above preferably contains also one or more of components selected from P in the range of 0.10% by weight or less, N in the range of 0.0040 to 0.030% by weight, Cu in the range of 0.001% by weight or more and S in the range of 0.10% by weight or less.

According to this invention, there is also provided an aperture grill for a color picture tube, characterized by being formed from any of the materials as set forth above.

According to this invention, there is also provided a color picture tube, characterized by having incorporated therein an aperture grill as set forth above.

### BEST MODE OF CARRYING OUT THE INVENTION

Our research work has shown that by employing 0.06% by weight or more of Si, it is possible to realize a tensile strength of 750 MPa or more by a strengthening phenomenon of Si in a solid solution, and that annealing by aging treatment makes it possible to obtain excellent magnetic properties as indicated by a Br (T)/Hc (A/m) ratio of 0.0025 or more.

A low-carbon steel used as a material for an aperture grill according to this invention is preferably a hot rolled steel having its carbide and nitride reduced by decarburization or denitriding treatment by vacuum degassing. Explanation will first be made of the reasons for the limitations to the kinds of elements contained by the steel used as a material for an aperture grill according to this invention and their contents.

Carbon has to be added, since it forms a solid solution in steel, increasing its hardness and improving its tensile strength and creep strength, but as a large amount of C leads to an increase of carbide hindering the etching resistance of steel, its content preferably has an upper limit of 0.05% by weight. Its content is more preferably 0.01% by weight or less. Its lower limit is preferably 0.0001% by weight, to which it can practically be lowered by vacuum degassing treatment or open coil annealing (OCA) by a batch annealing furnace. Its lower limit is more preferably 0.0002% byweight and still more preferably 0.005% by weight.

Manganese is an important component for this invention and while its high content is preferable for improving the creep characteristics of steel for an aperture grill with a lower limit of 0.60% by weight, its upper limit is preferably 3.0% by weight in view of the manufacturing cost and etching resistance of steel.

Silicon is in the range of 0.051 to 6.0% by weight, preferably from 0.051 to 1.0% by weight, and more preferably from 0.06 to 0.5% by weight. It has hitherto been necessary to restrict the amount of Si in an aperture grill to a small level, since it lowers the adhesive property of a blackening film. Owing to an improvement in the annealing conditions for blackening, a reduction in the unevenness of surface roughness, etc. however, it has become possible to mitigate the past restriction on the amount of Si. Therefore, Si is positively added to form a solid solution for strengthening steel and improving its mechanical properties, as well as improving its magnetic properties, particularly lowering its coercive force (Hc). If its content is lower than 0.051% by weight, its solid solution fails to improve the tensile strength of steel. If it exceeds 6.0% by weight, Si lowers the adhesive property of a blackening film. Therefore, its content is from 0.051 to 6.0%.

As sulfur segregates in the crystal grain boundary, thereby affecting the etching resistance of steel seriously and making it brittle, its content is preferably as low as 0.10% by weight or less, and more preferably 0.05% by weight or less.

Aluminum is an important element for this invention like manganese, and is used as a deoxidizer in a steel making process to improve the cleanness of steel. Therefore, its content is preferably 0.001% by weight or more. Its content has, however, an upper limit of 0.03% by weight, since with a larger amount of Al, its solid solution hardens and embrittles steel, lowers its etching resistance, combines with a solid solution of N to form AlN and reduce the solid solution of N, and thereby lowers the creep characteristics of steel.

Nitrogen has to be added, since it forms a solid solution in steel, increases its hardness and improves its tensile and creep strength. Moreover, it forms a nitride of high hardness and the fine dispersion of the nitride in the crystal grains of steel is effective for inhibiting the movement of its dislocation creep and particularly for improving its creep strength. Therefore, its content is preferably 0.0040% by weight or more, and more preferably 0.007% by weight or more. However, its content is preferably 0.03% by weight or less, and more preferably 0.017% by weight or less, since a higher nitrogen content results in the formation of excessive nitride and thereby a brittle material.

Copper can be added, since it forms a solid solution in steel and makes it possible to produce a material of high hardness and improved tensile and creep strength. When any copper is added, its content is preferably over 0.001% by weight, more preferably 0.002% by weight or more and still more preferably 0.003% by weight or more. However, its content is preferably 2.0% by weight or less and more preferably 0.1% by weight or less, since a higher copper content brings about a lower etching rate and thereby a contaminated etching solution.

Chromium can be added, since it forms a solid solution in steel and makes it possible to produce a material of high hardness and improved tensile and creep strength. When any chromium is added, chromium interacts with a solid solution of nitrogen remaining in steel and suppresses the diffusion of nitrogen forming a Cottrell atmosphere. Nitrogen has a particularly high rate of diffusion at a temperature as high as 455° C. and its own effect is low in suppressing the motion of dislocation at a high temperature. As compared with nitrogen, chromium has a low rate of diffusion even at a temperature as high as 455° C. and its interaction with nitrogen eventually makes it possible to suppress the diffusion of nitrogen and thereby the motion of dislocation. As a result, it realizes a material of lower creep elongation. The excess of chromium, however, lowers the magnetic properties of steel and therefore, its chromium content preferably has a lower limit of 0.001% by weight, more preferably 0.002% by weight and still more preferably 0.003% by weight. As the presence of too large an amount of chromium results in the formation of carbide impairing the magnetic properties of steel, its chromium content is preferably 0.1% by weight or less, more preferably 0.09% by weight or less and still more preferably 0.08% by weight or less.

Phosphorus has an upper limit of 0.10% by weight, since it impairs the etching resistance of steel.

Titanium may be added, if required. When it is added, its amount is preferably 0.10% by weight or less. Its excess over 0.10% by weight is undesirable, since it suppresses the recrystallization of steel during its annealing and lowers its magnetic properties, or necessitates its annealing at a higher temperature, causing it to buckle under heat.

Niobium may be added, if required. When it is added, its amount is preferably 0.10% by weight or less. Its excess over 0.10% by weight is undesirable, since it suppresses the recrystallization of steel during its annealing and lowers its magnetic properties, or necessitates its annealing at a higher temperature, causing it to buckle under heat.

Boron may be added, if required. When it is added, its amount is preferably 0.010% by weight or less. Its excess over 0.010% by weight is undesirable, since it vaporizes in a highly vacuum cathode-ray tube and lowers its vacuum degree.

Description will now be made of a process for manufacturing a thin steel sheet as a material for an aperture grill according to this invention. A molten metal obtained by an ordinary melting method and having the composition as described above is deoxidized by vacuum degassing or by using aluminum, silicon, etc., is continuously cast and is hot rolled to give a hot rolled sheet. After the removal of scale by pickling, the hot rolled sheet is cold rolled into a thickness of 0.2 to 0.3 mm. After its softening by annealing, the sheet is subjected to finish cold rolling into a predetermined thickness of 0.05 to 0.20 mm. A batch or continuous annealing furnace is used for its annealing. Its finish cold rolling may or may not be followed by surface roughening treatment, and is then followed by its heat treatment in a temperature range not causing its recrystallization. Its heat treatment is carried out preferably in a non-oxidizing atmosphere and more preferably in, for example, a reducing atmosphere containing nitrogen and hydrogen. Its surface roughening treatment may be carried out in any known manner, for example, in a temper rolling stage, or during its cold rolling into a predetermined thickness of 0.05 to 0.20 mm. It is also possible to rectify the shape of the sheet by a mechanical or hydraulic tension leveler before or after its heat treatment in a temperature range not causing its recrystallization.

The cold rolled sheet preferably has a surface roughness Ra (JIS B 0601) of 0.1 to 0.8 um and more preferably in the range of 0.4 to 0.6 um. If its surface roughness is less than 0.1 um, a resist may fail to adhere to it intimately, and if its surface roughness exceeds 0.8 um, a resist may adhere to it so intimately as to remain even at any site where it has to be melted by development.

### EXAMPLES

The invention will now be described in further detail by examples. Table 1 shows the chemical compositions of hot rolled sheets having a thickness of 2.0 mm as obtained by hot rolling slabs made from molten and vacuum degassed steels having different chemical compositions (Examples 1 to 4 and Comparative Examples 1 to 5). In Table 1, FT means the finish temperature of each hot rolled sheet. The hot rolled sheets were pickled with sulfuric acid and cold rolled into cold rolled sheets having a thickness of 0.2 to 0.3 mm. Then, they were annealed in a continuous annealing furnace and cold rolled into a thickness of 0.10 mm. Rolls having a specific surface roughness were used for the cold rolling to make cold rolled sheets having a controlled surface roughness Ra. The sheets having a specific surface roughness Ra given thereto were heat treated at a temperature not causing recrystallization. The cold rolling was alternatively followed by surface roughening treatment and heat treatment at a temperature not causing recrystallization. In Tables 1 and 2, surface roughening treatment was given by temper rolling in Examples 3 and 4 and Comparative Examples 3 to 5. Surface roughening was given by cold rolling in Examples 1 and 2 and Comparative Examples 1 and 2.

TABLE 1
Chemical compositions of steels and finish temperatures (FT)
of hot rolled sheets

| Example or | | | | | | | | | | |
|---|---|---|---|---|---|---|---|---|---|---|
| Comparative | Chemical composition (wt %) | | | | | | | | | FT |
| Example | C | Si | Mn | P | A1 | N | Ti | Nb | B | (° C.) |
| Example 1 | 0.032 | 0.07 | 0.62 | 0.011 | 0.003 | 0.0101 | TR | TR | TR | 858 |
| Example 2 | 0.009 | 0.06 | 0.62 | 0.008 | 0.002 | 0.011 | 0.022 | TR | 0.001 | 860 |
| Example 3 | 0.004 | 1.5 | 0.78 | 0.1 | 0.001 | 0.0077 | 0.008 | TR | 0.001 | 860 |
| Example 4 | 0.019 | 0.1 | 0.72 | 0.021 | 0.001 | 0.0088 | TR | 0.01 | TR | 852 |
| Comparative | 0.009 | 0.01 | 0.55 | 0.008 | 0.052 | 0.0077 | 0.02 | 0.01 | 0.001 | 865 |
| Example 1 | | | | | | | | | | |
| Comparative | 0.01 | 0.04 | 0.62 | 0.18 | 0.005 | 0.0121 | TR | 0.001 | 0.003 | 890 |
| Example 2 | | | | | | | | | | |
| Comparative | 0.22 | 0.03 | 1.10 | 0.04 | 0.002 | 0.0088 | 0.001 | TR | 0.002 | 899 |
| Example 3 | | | | | | | | | | |
| Comparative | 0.018 | 0.02 | 0.92 | 0.02 | 0.012 | 0.0123 | 0.002 | 0.001 | TR | 905 |
| Example 4 | | | | | | | | | | |
| Comparative | 0.004 | 0.01 | 0.29 | 0.04 | 0.001 | 0.0021 | TR | TR | 0.001 | 888 |
| Example 5 | | | | | | | | | | |

Table 2 shows the results of the tests conducted to examine the properties of the materials as obtained above. Tensile tests were conducted by employing an Instron tensile testing machine and creep elongation was examined by employing a creep testing machine (product of Tokai Seisakusho) and comparing elongation (%) as measured by loading the material with a stress of 294 N/mm² and holding it at 455° C. for 60 minutes in the air and elongation (%) as measured by loading the material with a stress of 294 N/mm² and repeating three times its holding at 455° C. for 20 minutes in the air.

The results of the creep strength tests were evaluated in accordance with the standard as stated below. The results were considered acceptable when the creep elongation of the steel as a material for an aperture grill as stated in the column of “Properties” in Table 2 was “0.3% or less”. The test conditions for a material for an aperture grill were so selected by assuming the blackening heat treatment of an aperture grill welded to a frame as to see if an aperture grill attached to a frame under tension after blackening could maintain its stretched position without loosening. More specifically, the creep elongation of each material for an aperture grill was measured after loading it with a stress of 294 N/mm² and holding it at 455° C. for 60 minutes. If the elongation is 0.3% or less, it is possible to obtain an aperture grill for a color picture tube which can be so incorporated into a picture tube that each of the tapes forming the aperture grill may maintain it stretched position without loosening. The color picture tube having such an aperture grill incorporated therein is a color picture tube which can display a clear and distortion-free picture without having any electron beam deflected by earth magnetism.

The surface roughness Ra was measured in accordance with JIS B 0601. The adhesion of resist was examined by a forced peeling test conducted by coating the steel sheet with a layer of water-soluble casein having a dry thickness of 5 to 6 um, cutting therein a pattern of squares reaching the sheet and sticking a Cellophane tape thereto. The result was acceptable (shown by 0 in Table 2) when the layer could not be peeled off at all, and was unacceptable (shown by X in Table 2) when it could be peeled off even partly.

After blackening, the aperture grill is heated for baking and glass sealing after it is actually incorporated in a color picture tube. It is assumed that the aperture grill may have a larger creep elongation than that of the material therefor as stated before. In view of the actual process for making a color picture tube as mentioned above, therefore, every aperture grill material according to this invention is required to have an elongation of 0.6% or less as determined by loading it with a stress of 294 N/mm² and repeating three times a cycle of heating it from room temperature to 455° C., holding it at that temperature for 20 minutes and cooling it therefrom to room temperature. Its elongation of 0.6% or less ensures that it is a material giving an aperture grill which is acceptable when incorporated in a picture tube.

As to the magnetic properties, the residual magnetic flux density Br (T) and coercive force Hc (A/m) of each material which had been annealed at 455° C. for 10 minutes were measured by the Epstein method (by putting a primary and a secondary winding thereon and applying an external magnetic field thereto—in the present case of evaluation, a magnetic field of 796 A/m) and the value of Br (T)/Hc (A/m) was obtained. The magnetic properties are preferably in the value of 0.0025 or more.

TABLE 2
Properties and results of evaluation

| | Properties | | | | | |
|---|---|---|---|---|---|---|
| | | | Magnetic | | | |
| Example or | | Creep | properties | | | |
| Comparative | T.S. | elongation | Br/Hc | Ra | Adhesion | Total |
| Example | (MPa) | (%) | (μT × m/A) | (μm) | of resist | evaluation |
| Example 1 | 780 | 0.008 | 0.0025 | 0.21 | ◯ | ◯ |
| Example 2 | 765 | 0.007 | 0.0032 | 0.22 | ◯ | ◯◯ |
| Example 3 | 812 | 0.008 | 0.0027 | 0.69 | ◯ | ◯ |
| Example 4 | 822 | 0.004 | 0.0026 | 0.44 | ◯ | ◯ |
| Comparative | 725 | 0.07 | 0.0027 | 0.17 | X | Δ |
| Example 1 | | | | | | |
| Comparative | 818 | 0.009 | 0.0015 | 0.11 | X | X |
| Example 2 | | | | | | |
| Comparative | 922 | 0.011 | 0.0009 | 0.29 | ◯ | X |
| Example 3 | | | | | | |
| Comparative | 812 | 0.028 | 0.0018 | 0.44 | ◯ | X |
| Example 4 | | | | | | |
| Comparative | 670 | 0.022 | 0.0028 | 0.8 | ◯ | X |
| Example 5 | | | | | | |

Table 2 shows that the products of this invention are superior in any aspect of the properties as the results of their total evaluation are indicated by a symbol 0 or 00. 0 or 00 indicates an acceptable range, i.e. a tensil strength is 750 Mpa or more, and a material having a creep elongation of 0.3% or less, magnetic properties (Br/Hc) of 0.0025 or more, a surface roughness Ra (JIS B 0601) of 0.1 to 0.8 μm and a good adhesion of resist as tested under the conditions stated before. OO indicates a particularly good material having magnetic properties (Br/Hc) of 0.003 or more. On the other hand, the products according to the comparative examples deviating from the scope of this invention are inferior in one or more aspects of the properties and the results of their total evaluation are indicated by a symbol X or A. A indicates a material which is somewhat inferior in tensile strength.

### INDUSTRIAL APPLICABILITY

As is obvious from the foregoing, the material of this invention for an aperture grill for a color picture tube exhibits high strength properties including high etching resistance and particularly high handling resistance owing to its rigidity and tensile strength elevated by the strengthening effects of a solid solution of silicon, and the aperture grill made from that material has high levels of tensile strength and high-temperature creep strength, a good adhesion of resist and high magnetic properties (Br/Hc) and yields an aperture grill type color picture tube ensuring a display free from any color drift.

1. A material for an aperture grill for a color picture tube, characterized by being composed of a low-carbon alloy steel containing 0.60% by weight or more of Mn, 0.051% by weight or more of Si and 0.03% by weight or less of Al, the balance of its composition being Fe and unavoidable impurities.

2. A material for an aperture grill for a color picture tube according to claim 1, characterized by being composed of a low-carbon alloy steel containing 0.05% by weight or less of C.

3. A material for an aperture grill for a color picture tube according to claim 1, characterized by having been heat treated for shape correction at a temperature not causing its recrystallization.

4. A material for an aperture grill for a color picture tube according to claim 2, characterized by having been heat treated for shape correction at a temperature not causing its recrystallization.

5. A material for an aperture grill for a color picture tube according to claim 1, characterized by having been subjected to surface roughening treatment giving a surface roughness Ra (JIS B 0601) of 0.1 to 0.8 μm, and having been heat treated for shape correction at a temperature not causing its recrystallization.

6. A material for an aperture grill for a color picture tube according to claim 2, characterized having been heat subjected to surface roughening treatment giving a surface roughness Ra (JIS B 0601) of 0.1 to 0.8 μm, and having been heat treated for shaped correction at a temperature not causing its recrystallization.

7. A material for an aperture grill as set forth in claim 1, further containing 0.10% by weight or less of P.

8. A material for an aperture grill as set forth in claim 1, further containing 0.0040 to 0.030% by weight of N.

9. A material for an aperture grill as set forth claim 1, further containing more than 0.001% by weight of Cu.

10. A material for an aperture grill as set forth in claim 1, further containing 0.10% by weight or less of S.

11. An aperture grill for a color picture tube made from a material for an aperture grill as set forth in claim 1.

12. A color picture tube in which an aperture grill as set forth in claim 11 is incorporated.

13. A material for an aperture grill as set forth in claim 2, further containing 0.10% by weight or less of P.

14. A material for an aperture grill as set forth in claim 2, further containing 0.0040 to 0.030% by weight of N.

15. A material for an aperture grill as set forth in claim 2, further containing more than 0.001% by weight of Cu.

16. A material for an aperture grill as set forth in claim 2, further containing 0.10% by weight or less of S.

17. An aperture grill for a color picture tube made from material for an aperture frill as set forth in claim 2.

18. A color picture tube in which an aperture grill as set forth in claim 17 is incorporated.

19. A material for an aperture grill as set forth in claim 6, further containing 0.10% by weight or less of P.

20. A material for an aperture grill as set forth in claim 19, further containing 0.0040 to 0.030% by weight of N.
